(19) United States
(12) Patent Application Publication
(10) Pub. No.: US 2012/0291649 A1
(43) Pub. Date: Nov. 22, 2012

(54) Electret composition

(76) Inventors: Troy R. Parrott, Rio Rancho, NM (US); Donna S. Senft, Rio Rancho, NM (US)

(21) Appl. No.: 13/506,765

(22) Filed: May 16, 2012

Related U.S. Application Data
(63) Continuation-in-part of application No. 10/365,865, filed on Feb. 13, 2003, now Pat. No. 8,202,608.
Application No. 10/365,865 is a continuation-in-part of application No. 09/668,397, filed on Sep. 22, 2000, now abandoned.

(51) Int. Cl. B32B 27/28; B41F 30/00; B32B 27/10; B32B 27/40; B32B 27/36

(52) U.S. Cl. 101/483; 428/537.5; 428/425.1; 428/423.7; 428/424.8

(57) ABSTRACT

A printing method and composition that is constructed from an electrostatically charged sheet having a top and bottom surface and a backing sheet. The backing sheet has top and bottom surfaces. The top surface includes a binding material. The top surface of the backing sheet is in contact with the bottom surface of the electrostatically charged sheet and retained by an attractive force. The binding material is preferably chosen to provide an electrostatic attraction between the electrostatically charged sheet and the backing sheet of approximately between 4 g/inch and 400 g/inch. The attractive force should be sufficient to couple the charged film to the backing sheet during the printing process all the way through until a user decides to uncouple the charged film from the backing sheet.

### CLAIM OF PRIORITY

This invention claims priority based upon U.S. application Ser. No. 09/668,397, filed Sep. 22, 2000. This invention also is a continuation-in-part of pending U.S. patent application Ser. No. 10/365,865 filed Feb. 13, 2003.

### FIELD OF INVENTION

This invention relates generally to printing on polymer electrostatically charged films, and more to an improved printing composition that is better adapted for printing in various printing presses, including high-speed flexographic, digital and wide format ink jet printers.

### BACKGROUND OF THE INVENTION

It is common practice to affix printed posters, calendars and the like to a flat, vertical surface, e.g., a wall. The purposes for doing so are wide and varied. For example, there is the college student who wants to decorate his or her dorm walls but cannot afford framed pictures and is prohibited by school authorities from mounting any materials requiring nails to be embedded in the walls. Like most students, this student will choose to decorate his or her dorm walls by affixing unframed printed posters with tape, tacks, or other adhesive materials.

Posters printed on electrostatically charged plastic films are particularly attractive for advertising and the like. The posters will adhere to a vertical surface for weeks or months without utilizing attachment methods that will damage the wall or require costly installation or removal procedures. The cost of the electrostatically charged material is substantially less than other products such as static cling vinyl which is often used for such purposes. In addition, electrostatically charged sheets will cling to a much larger class of surfaces than static cling vinyl.

The thickness of the plastic sheets is preferably in the range of 0.001 to 0.006 inches. Thin sheets weigh less than thicker sheets, and hence, require less electrostatic charge to stick to a vertical surface. In addition, thin sheets have less material per square foot than thicker sheets, and hence, have lower material costs.

Unfortunately, thin plastic sheets present problems when high speed printing presses are used to print the posters. To prevent stretching and other mechanical problems, the thin charged sheets must be attached to some form of thicker backing sheet that provides dimensional stability as well as stiffening of the article to be printed. The usual prior art backing sheet consists of a sheet of paper that is attached to the plastic sheet by an adhesive at the edges of the sheets. The combination of adhesive and electrostatic charge is sufficient to assure that the two sheets do not separate in standard printing presses (such as, for example, sheet fed or roll-to-roll printing presses). After the sheets are printed, the glued portions on the edges can be cut off leaving the charged sheet attached to the backing sheet solely by electrostatic force.

While this methodology has been successful with some forms of printers, there are high speed printers that subject the partially glued sheets to sufficient forces to cause the sheets to de-laminate during the printing process, leading to undesirable consequences. In addition, some printing systems, such as flexographic printing presses, operate on relatively narrow widths of stock that lack space for glue strips on the edges. The partially glued sheets also present problems when printed by silk screen techniques.

In addition to causing problems at the printing stage, a poorly bound backing sheet can cause problems when the printed material is bound in magazines and the like. One particularly attractive use for electrostatically charged posters is for advertising. The electrostatically charged poster and backing sheet are bound in magazines with a perforated edge that allows the reader to pull out the poster. The machinery that inserts these inserts can exert sufficient force on the poster to de-laminate the sheets. The de-laminated sheets may cause problems with the insertion mechanisms, and hence, cannot be used in this application.

Accordingly, it is the object of the present invention to provide an improved backing sheet for electrostatically charged sheets.

It is a further object of the present invention to provide an electrostatically charged film which does not substantially retain any adhesive when removed from the backing sheet.

The present invention is also directed towards web printing (e.g., printing material or a web from a roll through a printing press and rewound onto another roll) which is known to those of skill in the art as roll to roll printing.

Those of skill in the art will come to realize that the present invention may also be applicable to any type of printer or printing processes. The present invention provides an advantage to these printing processes in that the charged sheet and the backing sheet remain in contact which decreases the possibility of wrinkles or blemishes on the printed charge sheet during the printing process, especially at higher printing speeds.

Those of skill in the art will also come to realize that the present invention can also be used as cut sheets of material.

These and other objects of the present invention will become apparent to those skilled in the art from the following detailed description of the invention and the accompanying drawings.

### SUMMARY OF THE INVENTION

The present invention is a printing composition that is constructed from an electrostatically charged sheet having a top and bottom surface and a backing sheet. The backing sheet includes a sheet of paper having top and bottom surfaces. In one embodiment, the top surface includes a binding material having a dielectric constant greater than that of the paper. In another embodiment, the top surface includes a binding material including at least one chemical adhesive or chemical adhesive mixture. The top surface of the backing sheet is in contact with the bottom surface of the electrostatically charged sheet. The binding material is preferably chosen to provide an adhesive force between the electrostatically charged sheet and the backing sheet of approximately between 4 g/inch and 400 g/inch. The binding material may be constructed from a mixture of polymers, such as for example polyethylene, polyurethane, and polypropylene.

The novel features of the present invention will become apparent to those of skill in the art upon examination of the following detailed description of the preferred embodiment or can be learned by practice of the present invention. It should be understood, however, that the detailed description of the preferred embodiment and the specific examples presented, while indicating certain embodiments of the present invention, are provided for illustration purposes only because various changes and modifications within the spirit and scope of the invention will become apparent to those of skill in the art from the detailed description, drawings and claims that follow.

### BRIEF DESCRIPTION OF THE DRAWINGS

The accompanying figures further illustrate the present invention and, together with the detailed description of the preferred embodiment, assists to explain the general principles according to the present invention.

FIG. 1a is an exploded perspective view of a printing composition 10 according to the present invention;

FIG. 1b is another exploded perspective view of a printing composition 10 according to the present invention; and

FIG. 2 is an exploded perspective view of another printing composition 20 according to the present invention as described and disclosed below.

Additional aspects of the present invention will become evident upon reviewing the non-limiting embodiments described in the specification and the claims taken in conjunction with the accompanying figures, wherein like reference numerals denote like elements.

### DETAILED DESCRIPTION OF THE PREFERRED EMBODIMENT

The ideal backing sheet would adhere to the electrostatically charged sheet (or, film) by electrostatic attraction, chemical attraction, or a combination of electrostatic and/or chemical attraction, with sufficient force to assure that the sheets will not de-laminate on passing through the printing presses, magazine insert insertion machinery, or during certain end use applications of the invention (such as direct mail printings). Thus, for example, the attraction force should be sufficient to couple the charged film to the backing sheet during the printing process all the way through until a user decides to uncouple the charged film from the backing sheet. In addition, the attraction preferably should not be so great that the sheets cannot be manually separated without damaging the thin plastic poster. In a preferred embodiment, substantially all of any adhesive coatings should remain on the backing sheet when the charged film is removed from the backing sheet by a user.

The electrostatic force with which the electrostatically charged sheet is bound to the backing sheet is determined by the dielectric constant of the backing sheet surface that is in contact with the electrostatically charged sheet. In addition, the backing sheet can be held in place by chemically-based adhesion forces. As noted above, without applying an adhesive, a paper sheet does not typically bind to the electrostatically charged film with sufficient force to prevent de-lamination. On the other hand, paper represents the most economical choice of material. Accordingly, one preferred embodiment of the present invention utilizes a paper backing sheet that has been coated with a material with a dielectric constant that is greater than that of the untreated paper and which also interacts electrostatically or chemically with the plastic of the electrostatically charged sheet. In another embodiment, the present invention utilizes a backing sheet which is coated with one or more chemical adhesives. Moreover, those of skill in the art will realize that a backing sheet may be made of different materials other than strictly paper (such as, for example, plastic, aluminum, metal or other substrate that couples the backing sheet to the charged film until a user uncouples the charged film from the backing sheet). The choice of the type of backing sheet utilized is a design choice, and may be influenced by factors such as cost, printing process requirements or the end-use application for the finished product. In one preferred embodiment of the present invention, the binding material is a mixture of polymers.

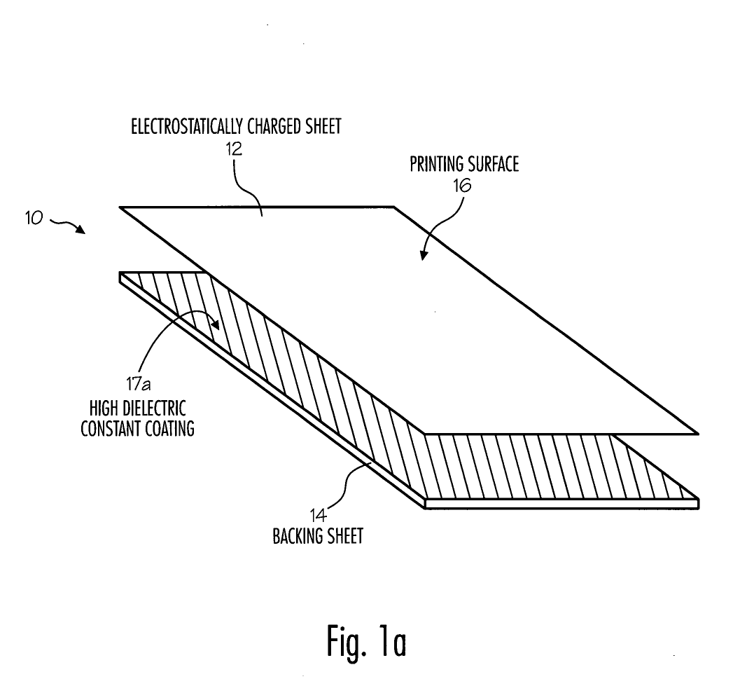

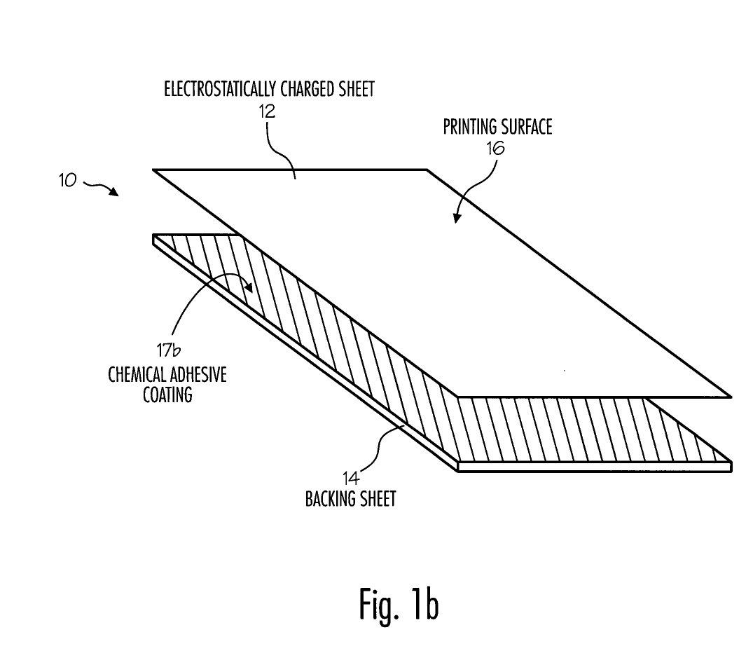

Refer now to FIG. 1a, which is an exploded perspective view of a printing composition 10 according to the present invention. Printing composition 10 is constructed from an electrostatically charged sheet 12 that is in contact with a backing sheet 14. On one surface (preferably the surface facing the charged sheet 12), backing sheet 14 has a high dielectric constant coating 17a applied to approximately its entire surface area (and applied preferably to approximately its entire surface area, but not necessarily). Electrostatically charged sheet 12 has a printing surface 16 which accepts ink during the printing process. Printing surface 16 may include one or more coating layers that aid in the absorption of ink. Such layers are particularly useful when water-based inks such as those utilized in inkjet printers are used. In one embodiment, the charged sheet 12 may be formed from a plastic polymer, such as for example polyethylene, polypropylene, polyester or like polymers.

FIG. 1b illustrates another embodiment of the present invention.

Here, printing composition 10 is constructed from an electrostatically charged sheet 12 that is in contact with a backing sheet 14. On one surface (preferably the surface facing the charged sheet 12), backing sheet 14 has a chemical adhesive coating 17b applied (and applied preferably to approximately its entire surface area, but not necessarily). Several types of exemplary adhesive coatings are available, such as, for example, non-reactive, reactive, natural or synthetic chemical adhesives. In this embodiment, electrostatically charged sheet 12 has a printing surface 16 which may accept and retain ink during the printing process. Printing surface 16 may include one or more coating layers that aid in the absorption of ink. Such layers are particularly useful when water-based inks such as those utilized in inkjet printers are used. In one embodiment, the charged sheet 12 may be formed from a plastic polymer, such as, for example, polyethylene, polypropylene, polyester or the like.

Thus, backing sheet 14 may be coated with a high dielectric constant material and/or a chemical adhesive coating on the side that makes contact with electrostatically charged sheet 12. The dielectric constant and/or chemical composition should be chosen such that the binding force is in the correct range for the printing and insertion machinery, while not being so great that the electrostatically charged sheet 12 cannot be removed manually from backing sheet 14 without damaging electrostatically charged sheet 12.

In the preferred embodiment of the present invention, a mixture of polymers is utilized for the coating. For example, a mixture of polyethylene, polypropylene, and polyurethane, can be utilized. The ratio of the polymers to one another in the mixture determines the dielectric constant of the resulting coating. The dielectric constant is adjusted such that the binding force between electrostatically charged sheet 12 and backing sheet 14 is approximately between 4 g/inch and 400 g/inch. The adhesion between the backer sheet and the thin charged sheet can be measured by a peel test as described in ASTM D1876-95. In this test, the force (e.g., peel force or peel strength) required to remove the charged sheet from the backer at a 180 degree angle is measured. The results are reported in grams of peel force per inch of width of the sample. Since the binding force also depends on the degree to which the electrostatically charged sheet is charged, the ratio of polymers that provides the correct binding force will depend both on the material from which the electrostatically charged sheet 12 is constructed and the degree to which that material was charged.

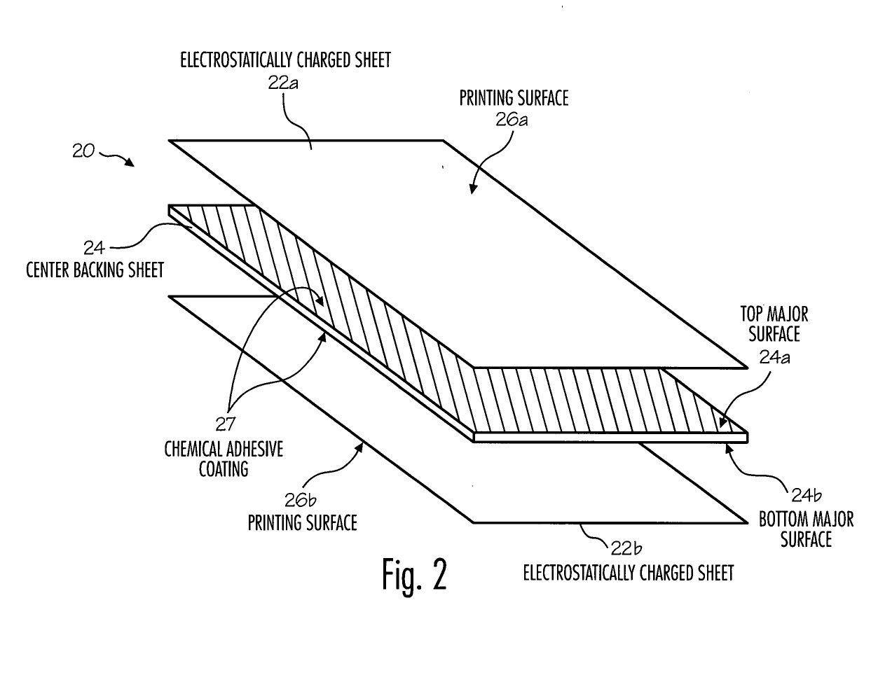

In still another embodiment of the present invention shown in FIG. 2, printing composition 20 may be constructed in a double sided manner, mirrored around a center backing sheet 24 having a top major surface 24a and a bottom major surface 24b. In this “sandwich” embodiment, preferably both the top and bottom surfaces of backing sheet 24 are adapted for coupling with two separate electrostatically charged sheets 22a, 22b. Each of the electrostatically charged sheets 22a, 22b have exterior (or, outer) printing surfaces 26a, 26b both of which face outward, away from backing sheet 24 and at least one of which is adapted to accept and retain ink during the printing process. A high dielectric constant and/or chemical adhesive coating on each major surface 24a, 24b of the backing sheet 24 is adapted to allow the adhesion or otherwise coupling of the backing sheet 24 to the two electrostatically charged sheets 22a, 22b.

In addition to providing improved binding of the electrostatically charged sheet to the backing sheet, the high dielectric coating provides another advantage. It is found experimentally, that when the electrostatically charged sheet is separated from the backing sheet, additional charge is transferred to the electrostatically charged sheet. That is, the act of separating the two sheets actually increases the electrostatic charge on the electrostatically charged sheet. This increase in charge is believed to result from the chemical interaction of the backing sheet and the electrostatically charged sheet. The relative magnitudes of the chemical and electrostatic adhesions can be estimated from the increase in adhesion observed after the sheets have been in contact with one another for some period of time. For example, after aging for 70 hours at 52° C., the adhesion measured by the peel test increased by a factor of between two and three over an unaged sample. Since the electrostatic attraction does not change with heat, the increase is due to the chemical attraction.

The preferred thickness of the backing sheet is determined by the requirements of the printing or insertion handling machinery, or by design requirements of the finished product. Thin sheets have the advantage of lower cost; however, there is a minimum thickness that must be maintained for the sheets to be processed by the machinery. In one embodiment of the present invention, the backing sheet preferably has a thickness between approximately 1 mil and 30 mil (i.e., 0.001 inches and 0.030 inches).

As noted previously, the electrostatically charged sheet can be constructed from a number of different materials or plastic polymers. The production of electrostatically charged sheets from, for example, polyester, polyethylene or polypropylene films is well known in the electret arts.

Various modifications to the present invention will become apparent to those skilled in the art from the foregoing description and accompanying drawings. Accordingly, the present invention is to be limited solely by the scope of the following claims.

As will be appreciated by one of ordinary skill in the art, the present invention may be embodied as a system, method, process or apparatus, or any combination thereof. Additionally, in the foregoing specification, the invention has been described with reference to specific embodiments. However, it will be appreciated that various modifications and changes can be made without departing from the scope of the present invention as set forth in the claims below. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented in the claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

Other variations and modifications of the present invention will be apparent to those of ordinary skill in the art, and it is the intent of the appended claims that such variations and modifications be covered. The particular values and configurations discussed above can be varied, are cited to illustrate representative embodiments of the present invention and are not intended to limit the scope of the invention. It is contemplated that the use of the present invention can involve components having different characteristics as long as the principle is followed.

1. A method for printing in printers, the method comprising the steps of:
introducing an electrostatically charged sheet having a top surface and a bottom surface;
introducing a backing sheet comprising at least a top surface, the top surface having a binding material; and
coupling the electrostatically charged sheet bottom surface to the backing sheet top surface by an attractive force to form a printing composition, the attractive force being sufficient to prevent uncoupling of the electrostatically charged sheet and the backing sheet during the printing process through and until a user decides to uncouple the electrostatically charged film from the backing sheet while preventing permanent adhesion between the electrostatically charged sheet and the backing sheet.

2. The method of claim 1, the attractive force comprising at least an electrostatic force.

3. The method of claim 2, the attractive force resulting from at least one chemical adhesive mixture.

4. The method of claim 1, the charged sheet top surface being adapted to accept and retain ink.

5. The method of claim 3, wherein the chemical adhesive mixture comprises a mixture of polymers.

6. The method of claim 1, the attractive force being set at approximately between 4 g/inch and 400 g/inch.

7. The method of claim 6, the charged sheet having a thickness of between approximately between 0.001 inches and 0.006 inches and the backing sheet having a thickness of between 0.001 inches and 0.030 inches.

8. The composition made according to the method of claim 2.

9. A printing laminate material comprising:
an electrostatically charged sheet having a top and a bottom surface, and a backing sheet comprising a sheet of paper having a top and a bottom surface, the backing sheet top surface having a chemical adhesive, the backing sheet top being in contact with the bottom surface of the electrostatically charged sheet.

10. The printing laminate material of claim 9, wherein the chemical adhesive comprises a mixture of polymers.

11. The printing laminate material of claim 10 wherein the mixture of polymer comprises polyethylene, and polypropylene polyurethane and like polymers.

12. The printing laminate material of claim 9 wherein the binding material is chosen to provide an attraction between the electrostatically charged sheet and the backing sheet of approximately between 4 g/inch and 400 g/inch.

13. The printing laminate material of claim 9, the electrostatically charged sheet comprising polyethylene, polypropylene or polyester.

14. A printing laminate material for use in a printing process, the composition comprising a first electrostatically charged sheet having a first outer surface and a first inner surface, a second electrostatically charged sheet having a second outer surface and a second inner surface, and a center sheet having a top major surface and a bottom major surface, the center sheet's top major surface being adjacently coupled to the first inner surface by a first attractive force sufficient to prevent uncoupling of the first electrostatically charged sheet from the center sheet during the printing process while preventing permanent adhesion between the first charged sheet and the center sheet, the center sheet's bottom major surface being adjacently coupled to the second inner surface by a second attractive force sufficient to prevent uncoupling of the first electrostatically charged sheet from the center sheet during the printing process while preventing permanent adhesion between the second charged sheet and the center sheet,

15. The laminate material of claim 14, the first electrostatically charged sheet's outer surface being adapted to accept and retain ink, the second electrostatically charged sheet's outer surface being adapted to accept and retain ink.

16. The laminate material of claim 15, the first and second attractive forces resulting from a chemical adhesive coating applied to the center sheet's top major surface and the center sheet's bottom major surface.

17. The laminate material of claim 15, the first and second attractive forces resulting from a high dielectric coating applied to the center sheet's top major surface and the center sheet's bottom major surface.

18. The laminate material of claim 15, the first attractive force resulting from a chemical adhesive coating applied to the center sheet's top major surface, the second attractive force resulting from a high dielectric coating applied to the center sheet's bottom major surface.

19. The laminate material of claim 14, the attractive force being created by a binding material applied to the center sheet's top and bottom major surfaces.

20. The laminate material of claim 19 wherein the chemical adhesive comprises a mixture of polymers.
